(19) United States
(12) Patent Application Publication
(10) Pub. No.: US 2026/0065202 A1
(43) Pub. Date: Mar. 5, 2026

(54) METHOD FOR PREDICTING A CO2 STORAGE RISK ASSESSMENT

(71) Applicant: SHELL USA, INC., Houston, TX (US)

(72) Inventors: Ligang LU, Houston, TX (US); Jie CHEN, Houston, TX (US); Ilyana FOLMAR, Houston, TX (US); Mohamed SIDAHMED, Rio de Janeiro (BR); Zexuan DONG, Houston, TX (US); Qiushuo SU, Houston, TX (US)

(21) Appl. No.: 19/106,305

(22) PCT Filed: Sep. 14, 2023
(86) PCT No.: PCT/US2023/074155

§ 371 Date: Feb. 25, 2025

Related U.S. Application Data
(63) Continuation of application No. 18/340,455, filed on Jun. 23, 2023.
(60) Provisional application No. 63/407,342, filed on Sep. 16, 2022.

(51) Int. Cl. G06Q 10/0635; G06Q 50/02

(52) U.S. Cl. CPC G06Q 10/0635; G06Q 50/02

(57) ABSTRACT

A method for predicting a CO₂ storage risk assessment includes determining a set of well integrity rules and determining a classification process based on the set of well integrity risks. Data relevant to the set of well integrity rules is extracted from data for a well located in a subsurface formation. The extracted data is provided to the classification process. A prediction for a subsurface CO₂ storage risk assessment is computed for the well. In a preferred embodiment, subsurface CO₂ storage risk assessment for two or more wells in the subsurface formation are used to compute a prediction of a formation CO₂ storage risk assessment.

### FIELD OF THE INVENTION

The present invention relates to a method for predicting a CO₂ storage risk assessment, and, in particular, to a classification process for making the prediction.

### BACKGROUND OF THE INVENTION

The increased demand for energy resulting from worldwide economic growth and development has contributed to an increase in concentration of greenhouse gases (GHG) in the atmosphere. This has been regarded as one of the most important challenges facing humankind in the 21st century. To mitigate the effects of GHG, efforts have been made to reduce the global carbon footprint.

Efforts to mitigate the release of GHG have led to a variety of technologies such as CCUS or CCS (Carbon Capture, Utilization and Sequestration, or Carbon Capture and Storage). With respect to geologic sequestration, efforts have been directed towards injecting gaseous or supercritical CO₂ into a subsurface formation.

The use of depleted hydrocarbon reservoirs has been considered for CO₂ storage. Depleted oil and gas reservoirs are suitable locations for sequestering CO₂ owing to their rock and structural properties and access to required infrastructure. In particular, abandoned wells in these reservoirs can be used for injecting CO₂ without investing in drilling new wells saving both time and cost.

CCS is currently constrained by the availability of sufficient de-risked pore space for safe storage. Depending on the type of geological storage in saline aquifers or depleted hydrocarbon bearing formations, multiple pathways could exist for CO₂ migration. It is important to understand the integrity of a well for assessing risk associated with CO₂ containment. In particular, it is important to determine the likelihood of undesirable leakage of CO₂ into unwanted areas, such as groundwater zones.

It is important to understand the integrity of a well for assessing risk associated with CO₂ containment. In particular, it is important to determine the likelihood of undesirable leakage of CO₂ into unwanted areas, such as groundwater zones.

Accordingly, significant effort is required from a subject matter expert to identify relevant information which often results in longer lead times of up to a year for a CO₂ sequestration site to mature. Reducing the lead time in maturing a site for CO₂ injection could result in faster CCS project delivery timelines and contribute to our broader goal of achieving net-zero targets.

One challenge in the well integrity evaluation is identification of potential CO₂ migration paths of fluids out of the storage complex. Depending on the areal location and the depth of penetration, legacy wells may be exposed to CO₂ plume and/or elevated bottomhole pressure due to the lifted formation brine (if CO₂ stored in a saline aquifer) propagating from CO₂ injection wells. Another challenge for injecting CO₂ into the depleted reservoir is related to CO₂ phase behaviour. Expansion of the CO₂ may lead to very low temperatures in the well, posing limitations on well design, integrity, and operability, and injectivity as hydrates may form. Alternatively, in case of a strong aquifer, water backfills the porous formation after the hydrocarbons are produced from the reservoir. Accordingly, a significant pressure is required for injecting coz to overcome the water pressure in the formation and limited capacity is available for storage without potential risking caprock integrity. Compression of the gas requires energy with a related GHG footprint.

Another challenge facing the injection of CO₂ the structure of the subsurface formation. CO₂ is light i.e., less dense than water, and will naturally travel upwardly in the formation because of buoyancy. Therefore, the formation should have a high-quality seal to avoid leak paths that could result in release into the environment. When upward mobility is limited, CO₂ will then migrate laterally potentially encountering additional leaks paths related to lack of closure, faults, or improperly abandoned wells. This presents limitations of where CO₂ can be responsibly injected and necessitates extensive CO₂ monitoring activities for a prolonged period to ensure the CO₂ remains in the subsurface formation.

There remains a need to improve accuracy and efficiency of CO₂ storage risk assessments.

### SUMMARY OF THE INVENTION

According to one aspect of the present invention, there is provided a method for predicting a CO₂ storage risk assessment, comprising the steps of: a) determining a set of well integrity rules; b) determining a classification process based on the set of well integrity rules; c) providing data for a first well located in a subsurface formation; d) extracting data relevant to the set of well integrity rules from the data for the first well; e) providing the extracted data to the classification process, and f) computing a prediction for a first subsurface CO₂ storage risk assessment for the first well.

### BRIEF DESCRIPTION OF THE DRAWINGS

The method of the present invention will be better understood by referring to the following detailed description of preferred embodiments and the drawings referenced therein, in which:

FIG. 1 is a schematic diagram of one example of a set of well integrity rules according to one embodiment of the present invention; and

FIGS. 2 and 3 are examples of a risk assessment performed in accordance with one embodiment of the present invention for a single well and for three wells in the same formation.

### DETAILED DESCRIPTION OF THE INVENTION

The present invention provides a method for predicting a well risk level for CO₂ containment. The method involves a classification process.

A set of well integrity rules is used for determining a classification process. Preferably, the set of well integrity rules is based on domain or industry guidance, and/or regulatory requirements.

The set of well integrity rules include technical criteria that can be used to determine the current well status and potential leak paths for CO₂ migration and/or pressure impact from the target formation. Examples of criteria that may be used in the set of well integrity criteria include, without limitation, presence of a cap rock seal, casing integrity, open or closed perforations in the wells, proximity to groundwater zone, isolation of groundwater zones using plugs or otherwise, fluid communication with a permeable zone, industry standards, industry guidelines, governmental regulations, and combinations thereof. Other suitable criteria will be understood by those skilled in the art.

The resulting risk assessment may be a relative risk level. Examples of relative risk levels include, without limitation, binary (e.g., yes/no) labels, high-medium-low labels, and/or a scale of risk levels having a finer level of detail. Depending on the criteria, different types of risk labels associated with certain well integrity criteria may be used within the same set of risk labels. For example, in certain embodiments, a yes/no risk level may be used for the presence or not of a cap rock seal, while a scale of risk level may be used as an indicator of casing integrity.

Examples of classification processes include, without limitation, artificial intelligence, machine learning, and deep learning. It will be understood by those skilled in the art that advances in classification processes continue rapidly. The method of the present invention is expected to be applicable to those advances even if under a different name. Accordingly, the method of the present invention is applicable to the further advances in classification processes, even if not expressly named herein.

The classification process is an unsupervised process, a supervised process, or a semi-supervised process. In one embodiment, a supervised process is made semi-supervised by the addition of an unsupervised technique.

The classification process may be trained with data selected from the group consisting of real well data, synthetically generated well data, and/or augmented well data.

In a supervised classification process, the training well data set is labeled to provide examples of inferences of contextual relationships and the impact of the relationship on a well integrity criterion.

Data for a well located in a subsurface formation of interest is applied to an extracting step to extract data relevant to the set of well integrity rules. The extracted data is provided to the classification process. A prediction for a subsurface CO₂ storage risk assessment is computed for the well.

The data for the well may be legacy data, recent data, and combinations thereof.

Well data may include, such as, for example, without limitation, daily drilling reports, cementing reports, well completion reports, workover reports, abandonment reports, general well data, pressure tests, mud record, information about cores taken, geological reports, abandonment or plug back, casing or liner data, cement data, and/or daily work summary. Other data may include the depth of groundwater zone. Data relevant to well integrity rules include, for example, without limitation, stratigraphy, lithology, permeability, cap rock seal integrity, casing integrity, plug integrity, and depths.

As noted above, depleted oil and gas reservoirs have been considered for storing CO₂ because they have desirable structural features, in particular, seal and trap structures to hold CO₂ for long periods of time. Further, the sites often have infrastructure such as pipelines, and accessibility to roadways that can be reused for CCS sites. Abandoned wells drilled in these reservoirs can be used to inject CO₂ but because the wells may have been drilled from years to decades ago, a well integrity evaluation is important before making any injection plans.

Alternatively or in addition, recent well data may be determined from existing or new wells.

The subsurface CO₂ risk assessment predicted from well data can be considered as an indicator of a vertical risk assessment, meaning that the prediction provides a localized assessment for the formation proximate the well. In a preferred embodiment, predictions for two or more wells are contextually assessed to compute a formation CO₂ storage risk assessment.

The formation CO₂ risk assessment can be considered as an indicator of an areal risk assessment, meaning that the prediction provides an assessment for the formation proximate and between the wells. Contextual assessment may reveal, for example, migration pathways, a change in depth for a specific formation layer determined from well data may indicate a fracture that may or may not provide fluid communication. Such fluid communication may be an indicator of increased risk for use of the formation for CO₂ storage.

In a preferred embodiment, data extracted from data for an additional well located in the subsurface formation may be provided to the classification process. Based on the well integrity rules, a prediction for the subsurface CO₂ storage risk assessment is computed for the additional well.

In another preferred embodiment, a subsurface CO₂ storage risk assessment for one well may be modified in view of a subsurface CO₂ storage risk assessment for another well in the same formation. For example, a subsurface CO₂ storage risk assessment for one well may show a layer in the subsurface formation that appears to be a low risk for CO₂ storage. However, a subsurface CO₂ storage risk assessment for another well may show a high risk for CO₂ storage in the same layer.

In another embodiment, the method may include the step of providing a recommendation for example, without limitation, to repair one or more wells, abandon a well, modifying a CO₂ injection scheme, and/or injecting CO₂ at a specified depth. This recommendation may be based on a subsurface CO₂ storage risk assessment for one or more wells, and/or a formation CO₂ storage risk assessment.

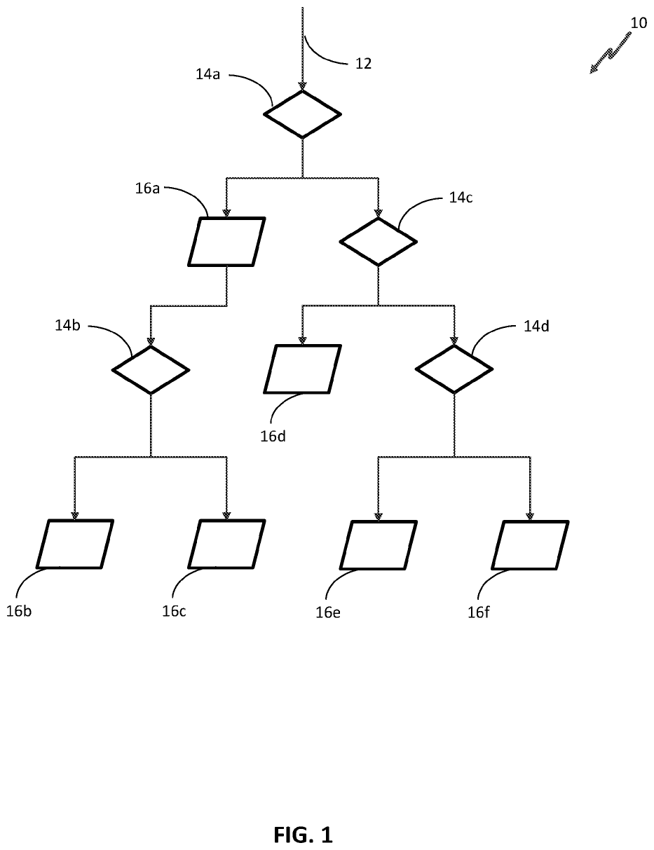

Referring now to FIG. 1 illustrating one embodiment of a set of well integrity rules for the present invention 10, extracted well data 12 is provided to a classification process wherein the extracted well data 12 is queried with well integrity criteria 14. An initial and/or intermediate result of a well integrity criterion 14 may be a risk indicator 16 and/or a pass to another well integrity criterion 14. Ultimately, the classification process computes a prediction for a CO₂ storage risk assessment for a well for which the extracted well data 12 was provided.

For example, the extracted well data 12 may be interrogated for an initial well integrity criterion 14a, for example, related to a cap rock seal.

Following the left-hand side of FIG. 1, the initial well integrity criterion 14a may result in a high-risk indicator 16a. However, the classification process is trained to consider contextual relationships between well integrity criteria 14, such that the analysis continues on the left-hand side of FIG. 1. In response, a query for an intermediate well integrity criterion 14b, for example, related to isolation of the well from a groundwater zone, may result in a higher-risk indicator 16b or a medium-risk indicator 16c, depending on the response to the intermediate well integrity criterion 14b.

On the right-hand side of FIG. 1, the extracted well data 12 passes the initial well integrity criterion 14a and is then interrogated with an intermediate well integrity criterion 14c, for example related to isolation of the well from a groundwater zone, may result in a higher-risk indicator 16d or a pass to another intermediate well integrity criterion 14d. Interrogation by the intermediate well integrity criterion 14d, for example related to isolation of the well from permeable zones in the formation, may result in a medium-risk indicator 16e or a low-risk indicator 16f, depending on the response to the intermediate well integrity criterion 14d.

The well integrity criteria 14 and resulting risk indicators 16 referred to in the discussion of FIG. 1 are provided as examples only. Other criteria may be used instead of or in combination with the above. Also, the order of the criteria 14 may be modified in accordance with the present invention 10. Further, the discussion above shows the intermediate well integrity criteria 14b and 14d are the same on the left-hand and right-hand sides of FIG. 1. However, the criteria 14b and 14d may not be the same.

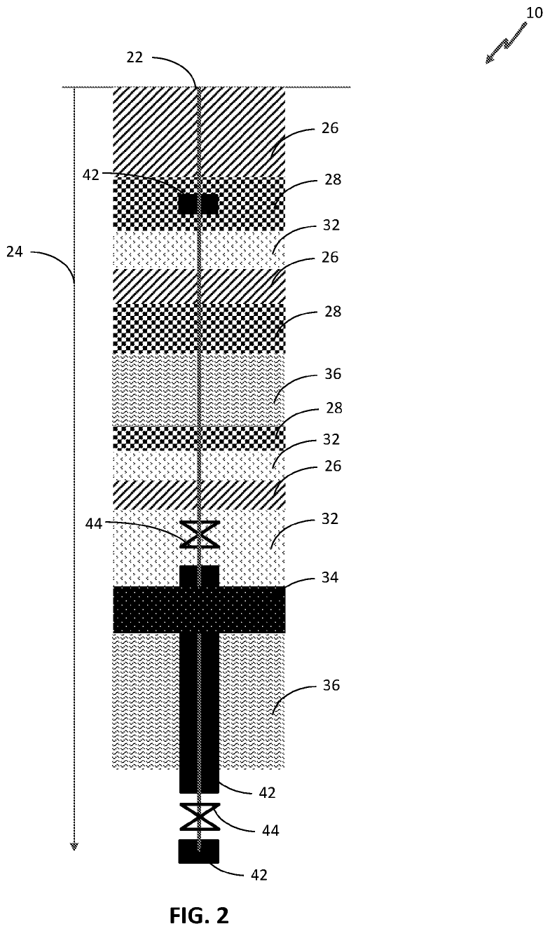

An example of a subsurface CO₂ storage risk assessment prepared by the method of the present invention for an existing well 22 based on legacy well data is illustrated in FIG. 2. The risk assessment provides a prediction for a low-risk CO₂ storage site is depicted as a function of depth 24.

FIG. 2 provides a simplified version of a formation stratigraphy and lithology for the formation proximate the well 22. Layers having forward slashes depict layers of unknown lithology 26. Layers providing a cap seal 28 are represented by checkered fill, while permeable layers 32 are shown with a divot fill. The permeable layers 32 were identified as medium-risk storage sites. A designated main seal layer 34 is depicted by light dots in a dark fill. FIG. 2 shows two permeable layers as having a low-risk CO₂ storage site 36, depicted with a wave fill.

The risk assessment shows the presence of a cement plug 42 shown with a solid fill and permanent bridge plugs 44.

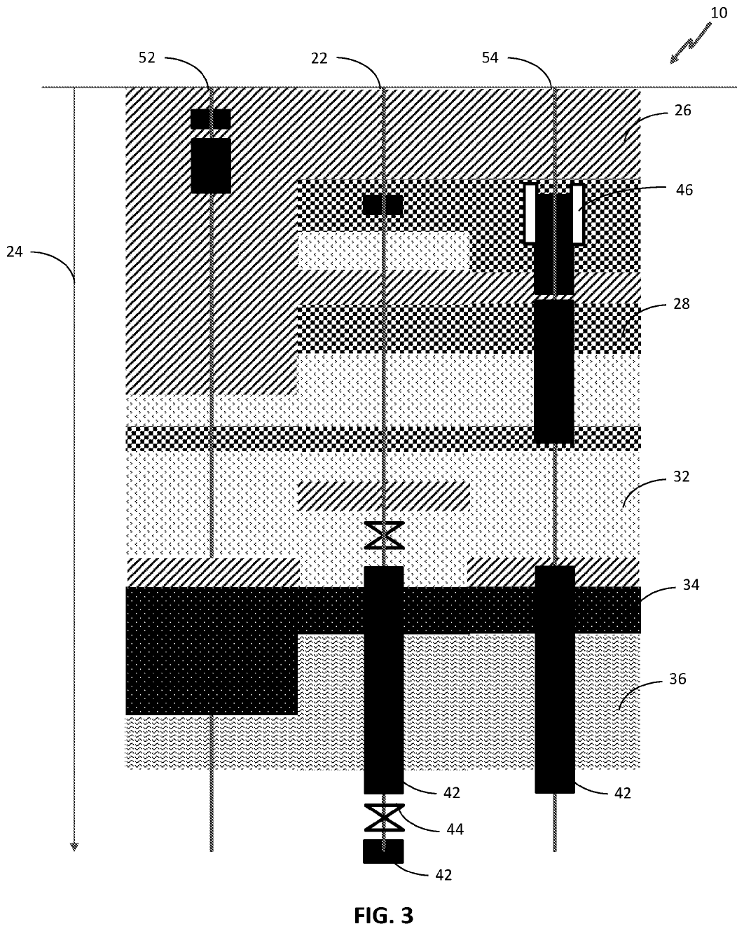

FIG. 3 illustrates an example of a formation CO₂ storage risk assessment prepared by a preferred embodiment of the method of the present invention for a formation having two additional wells 52, 54. The risk assessment for the well 22 from FIG. 2 is shown in the center of FIG. 3.

As for FIG. 2, FIG. 3 provides a simplified version of a formation lithology for the formation proximate the well 22. Layers having forward slashes depict layers of unknown lithology 26. Layers providing a cap seal 28 are represented by checkered fill, while permeable layers 32 are shown with a divot fill. The permeable layers 32 were identified as medium-risk storage sites. A designated main seal layer 34 is depicted by light dots in a dark fill. Another permeable layer was proposed as a low-risk CO₂ storage site 36 and is shown with a wave fill. FIG. 3 shows one embodiment of the invention, where a low risk assessment for the upper permeable layer 36 for well 22 in FIG. 2 was modified to a medium risk in view of the risk assessment of well 52.

The risk assessment shows the presence of a cement plug 42 shown with a solid fill and permanent bridge plugs 44. Well 54 also has casing cement 46 designated by open fill.

While preferred embodiments of the present invention have been described, it should be understood that various changes, adaptations, and modifications can be made therein within the scope of the invention(s) as claimed below.

What is claimed is:

1. A method for predicting a CO₂ storage risk assessment, comprising the steps of:
a) determining a set of well integrity rules;
b) determining a classification process based on the set of well integrity rules;
c) providing data for a first well located in a subsurface formation;
d) extracting data relevant to the set of well integrity rules from the data for the first well;
e) providing the extracted data to the classification process; and
f) computing a prediction for a first subsurface CO₂ storage risk assessment for the first well.

2. The method of claim 1, further comprising the steps of:
g) providing data for a second well located in the subsurface formation;
h) extracting data relevant to the set of well integrity rules from the data for the second well;
i) providing the extracted data to the classification process;
j) computing a prediction for a second subsurface CO₂ storage risk assessment for the second well; and
k) computing a prediction of a formation CO₂ storage risk assessment based on the first subsurface CO₂ storage risk assessment and the second subsurface CO₂ storage site assessment.

3. The method of claim 2, step (k) further comprises modifying the first subsurface CO₂ storage risk assessment in view of the second subsurface CO₂ risk assessment.

4. The method of claim 1, wherein the set of well integrity rules comprises criteria selected from the group consisting of presence of a cap rock seal, well casing integrity, open or closed perforations in the wells, proximity to groundwater zone, isolation of groundwater zones using plugs or otherwise, fluid communication with a permeable zone, industry standards, industry guidelines, governmental regulations, and combinations thereof.

5. The method of claim 1, wherein the first subsurface CO₂ storage risk assessment is a vertical risk assessment.

6. The method of claim 2, wherein the second subsurface CO₂ storage risk assessment is a vertical risk assessment.

7. The method of claim 2, wherein the formation CO₂ storage risk assessment is an areal risk assessment.

8. The method of claim 1, further comprising the step of providing a recommendation for repairs to the first well, abandoning the well, modifying an injection scheme, injecting CO₂ at a specified depth, and combinations thereof.

9. The method of claim 2, further comprising the step of providing a recommendation for repairs to one or more of the first well and the second well, abandoning one or more of the first well and the second well, modifying an injection scheme, injecting CO₂ at a specified depth, and combinations thereof.

10. The method of claim 1, wherein the classification process is selected from a supervised classification process, an unsupervised classification process, and a semi-supervised classification process.

11. The method of claim 1, wherein the classification process is trained with data selected from the group consisting of real well data, synthetically generated well data, augmented well data, and combinations thereof.
